(19) United States
(12) Patent Application Publication
(10) Pub. No.: US 2005/0167911 A1
(43) Pub. Date: Aug. 4, 2005

(54) Game machine

(75) Inventor: Haruo Inoue, Tokyo (JP)

Correspondence Address: YOUNG & THOMPSON, 745 SOUTH 23RD STREET, 2ND FLOOR, ARLINGTON, VA, 22202, US

(73) Assignee: DRAGON CO., LTD., TOKYO (JP)

(21) Appl. No.: 10/918,476

(22) Filed: Aug. 16, 2004

(30) Foreign Application Priority Data
Feb. 2, 2004 (JP) 2004-025080

(51) Int. Cl. G06F 17/00

(52) U.S. Cl. 273/142 C

(57) ABSTRACT

A slot machine is provided with first, second and third reels having plural symbols, which include “7”, “star” and so forth, on the periphery thereof and driven to rotate by a stepping motor. After each reel stops rotating, win or loss is determined according to a symbol combination arranged on a movable winning line. The movable winning line is formed of a bar-like member. The moving mechanisms are respectively connected with opposite ends of the movable winning line to move the respective ends independently.

### BACKGROUND OF THE INVENTION

1. Field of the Invention

The present invention relates to a game machine, more specifically to a game machine in which win or loss is determined according to symbol combination displayed in a stopped state on a winning line provided in a display section.

2. Explanations of the Prior Arts

There is a game machine provided with a symbol display device that stops displaying the symbols in motion after a random period or by operating a stop button. There have been known a slot machine and a pachinko machine as examples of such game machine. A mechanical rotation reel or an electronic display apparatus including a liquid crystal display device is used as the symbol display device.

In the symbol display device with the mechanical reel, the plural reels having plural kinds of symbols on the periphery thereof are arranged horizontally. As a game starts, each reel is rotated simultaneously, and then symbols are displayed in motion through a display window attached to a front surface of the reels. When each reel stops rotating in sequence, at least one symbol to one reel is displayed.

In the game machine having the symbol display device, win or loss is determined according to symbol combination on a winning line. In case of determining the win, predetermined amount of coins are paid out according to the type of the winning. For example, when three reels arranged horizontally are respectively stopped, three symbols of each reel are displayed through the display window, that is a total of nine symbols can be observed. There is a total of five winning lines that consist of three horizontal lines and two diagonal lines in a general slot machine. The player wins the game when a predetermined winning symbol combination is completed on one of these winning lines, and therefore the corresponding amount of coins are dispensed.

In the symbol display device with the mechanical reels, the winning line is printed on a transparent board disposed in front of the reels. However, the printed winning line (hereinafter referred to as a fixed winning line) is fixed, so that it is not enough to increase the player's expectation. To make matters worse, it is difficult to see the fixed winning line if the fixed winning line is irradiated by light emitted from decorating member, which is attached around the symbol display device. In addition, since the number of effective fixed winning lines increases according to a bet, a player cannot find immediately the line on which the winning is completed.

In order to solve the above problem, Japan Patent Laid-Open publication No. 11-33163 discloses the display device in which grooves corresponding to each winning line are formed on a transparent board. The grooves are irradiated from the side to reflect light diffusely, so that the intended winning line is illuminated with constant brightness. Therefore, it is possible to easily confirm the illuminated winning line. However, since every winning line is fixed, the winning line itself does not contribute to performance of determining win or loss. In addition, in terms of visual appeal, the fixed winning line is not enough to increase the player's expectation.

Moreover, the symbol display device with the electronic display apparatus can change freely displaying patterns of a winning line (hereinafter referred to as a virtual winning line); however, since the virtual winning line is a very thin straight line, the visual appeal to the player is low. Additionally, the virtual winning line is displayed instantly upon stopping the reels, so that it lacks variation and entertainment to induce the player's interest.

### SUMMARY OF THE INVENTION

A main object of the present invention is to provide a game machine for clearly indicating a position of a winning line.

Another object of the present invention is to provide a game machine including a variable and interesting winning line.

A further object of the present invention is to provide a game machine in which the winning line is moved so as to correspond to all the positions in which a winning is completed.

A further object of the present invention is to provide a game machine for providing a player with expectations for win until the winning line stops moving after symbols have been displayed in a stopped state.

To attain the above object, the winning line is formed of a bar-like member and moved to plural positions in a display section by a moving mechanism.

According to the game machine of the present invention, since the winning line is changed dynamically, the visual appeal to the player is enhanced so that it is possible to raise player's expectations for completion of the winning.

### BRIEF DESCRIPTION OF THE DRAWINGS

The above and other objects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is an external perspective view of a slot machine to which the present invention is applied;

FIG. 2 is an exploded perspective view of a display section of the slot machine;

FIG. 3 is a perspective view showing constitution of a moving mechanism;

FIG. 4 is a perspective view showing a state in which a movable winning line is attached to the moving mechanism through an attachment frame;

FIG. 5A is a top plan view of the display section of the slot machine wherein the movable winning line is in a horizontal state;

FIG. 5B is a side view of the display section of the slot machine wherein the movable winning line is in a horizontal state;

FIG. 6A is a top plan view of the display section of the slot machine wherein the movable winning line is tilted;

FIG. 6B is a side view of the display section of the slot machine wherein the movable winning line is tilted;

FIG. 7 is a cross-sectional view showing constitution of the movable winning line;

FIG. 8 is a block diagram showing electric constitution of the slot machine;

FIG. 9 is a view showing an example in which a symbol combination is changed “loss” into “win” by moving the movable winning line;

FIG. 10 is a view showing an example in which a winning symbol combination to be effective is changed into another one having a higher payout rate by moving the movable winning line;

FIG. 11A is a view showing a display panel in which a fixed winning line is formed;

FIG. 11B is a view showing a state of using both the display panel and the movable winning line;

FIG. 12 is an external front view of a pachinko machine to which the present invention is applied; and

FIG. 13 is a view showing a state in which the present invention is applied to a sub game unit.

### DETAILED DESCRIPTION OF THE EMBODIMENTS

A slot machine is provided with a display section for displaying plural kinds of symbols in motion or in a stopped state. After the symbols stopped, win or loss is determined according to symbol combination displayed on the display section.

In case of an electronic display section, dynamic virtual reels are drawn in plural display areas (e.g. nine or fifteen areas). The display areas are arranged in a square or rectangular matrix. As an example of such display section, a liquid crystal screen is used. Symbol image rows are movably displayed so as to flow in plural display areas in a vertical direction, and then displayed therein in the stopped state.

On the other hand, in case of a mechanical display section, plural reels having symbols on the periphery thereof are arranged in a line, and individually rotated by a stepping motor to be displayed in the stopped state.

An electronic or mechanical game machine of the present invention is provided with a moving mechanism for moving a winning line for showing a position of a winning symbol combination. The winning line is provided in an appropriate position in the display section. The moving mechanisms are respectively connected with the opposite ends of the winning line through a movable connector. The opposite ends of the winning line can be moved independently in the up and down direction.

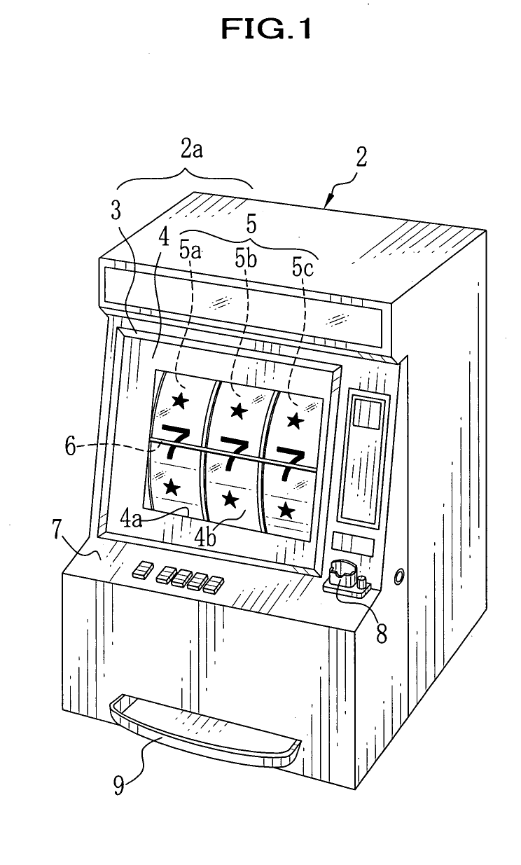

As an example of the game machine of the present invention, a mechanical slot machine 2 is explained. As shown in FIG. 1, a display section 2a of the slot machine 2 includes a rectangular attachment frame 3, a display panel 4 attached to the attachment frame 3 and a reel unit 5 incorporated in the slot machine 2 behind the display panel 4. The reel unit 5 is constituted of rotatable first-third reels 5a, 5b and 5c which are arranged horizontally. A rectangular display window 4a is formed in the display panel 4. A transparent board 4b made of glass or acrylic resin is fitted in the display window 4a, so that a part of the reel unit 5 can be observed through the display window 4a. The various kinds of symbols are arranged at constant intervals externally around the first-third reels 5a, 5b and 5c. When the reels stop rotating, three symbols to one reel are observed through the display window 4a.

A movable winning line 6 formed of a bar-like member is provided on the attachment frame 3 so as to traverse the display window 4a of the display panel 4. The opposite ends of the movable winning line 6 are respectively connected with after-mentioned moving mechanisms 13 through an after-mentioned movable connector 10. The moving mechanism 13 can move independently the opposite ends of the movable winning line 6 in the up and down direction. The movable winning line 6, which is a bar-like member, shows the winning symbol combination arranged linearly for example.

Namely, the movable winning line 6 can move to one line of five virtual lines that consist of three horizontal lines and two diagonal lines connecting virtually the symbols of each reel in a straight line. The movable winning line 6 traverses the three symbols.

It is not necessary to display the winning symbol combination in the position on which the movable winning line 6 exists at the start of the game. If there is the winning symbol combination on any virtual line, the movable winning line 6 may be moved on that virtual line by the moving mechanism 13 after each reel 5a-5c have stopped.

There is an operation panel 7 below the display panel 4. The operation panel 7 is provided with various buttons such as a start button, a bet button and a payout button. A coin slot 8 is formed beside the operation panel 7. A player bets by inserting the coin through the coin slot 8 and by depressing the bet button. When the win is decided, a coin dispenser is driven to pay out prize coins in a coin saucer 9, which is provided near the bottom of the slot machine 2. The player can also bet the coins accumulated in a credit counter (not shown), in addition to the coins actually inserted through the coin slot 8.

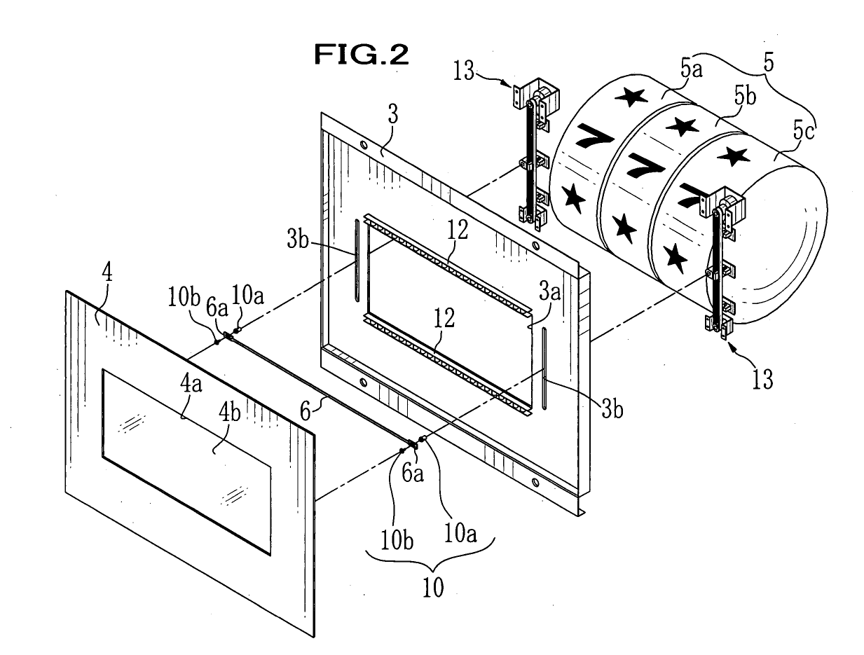

As shown in FIG. 2, in the attachment frame 3, a rectangular opening 3a is formed in a position corresponding to the display window 4a of the display panel 4. Light sources 12 having plural light-emitting diodes (LED) are attached to upper and lower sides of the opening 3a. The light source 12 is used to irradiate the movable winning line 6. In addition, vertically long slits 3b are formed in the attachment frame 3 along both sides of the opening 3a.

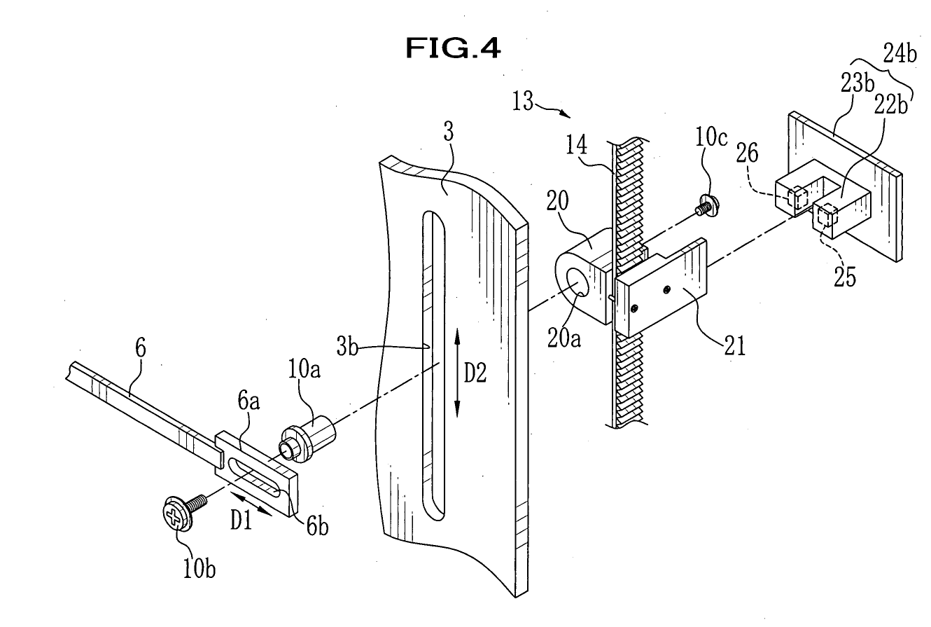

The opposite ends of the movable winning line 6 are attached to moving mechanisms 13 through the movable connector 10 (see FIG. 4). The movable connector 10 includes a pair of attachment bushes 10a of which one end is inserted in the slit 3b to be connected with the moving mechanism 13 and the other is connected with a pair of attachment fittings 6a attached to the opposite ends of the movable winning line 6, plural screws 10b for fixing the respective attachment fittings 6a in the attachment bushes 10a, and plural screws 10c (see FIG. 4) for fixing the respective attachment bushes 10a in the moving mechanisms 13.

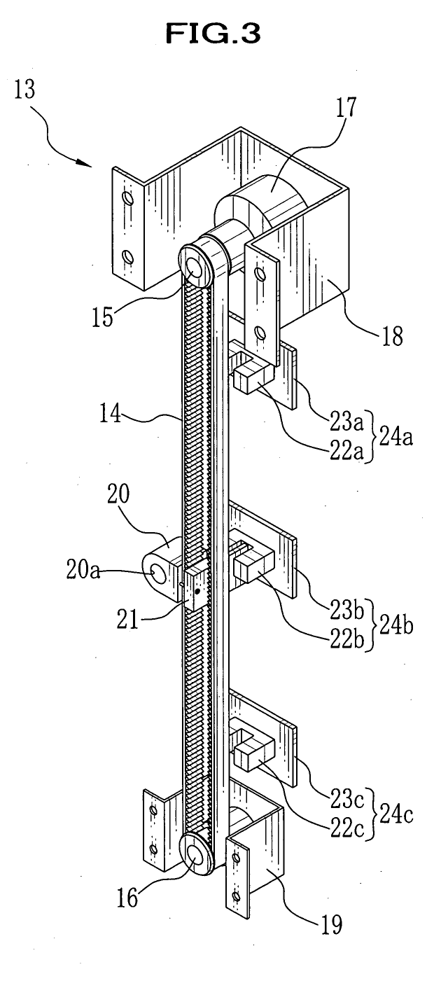

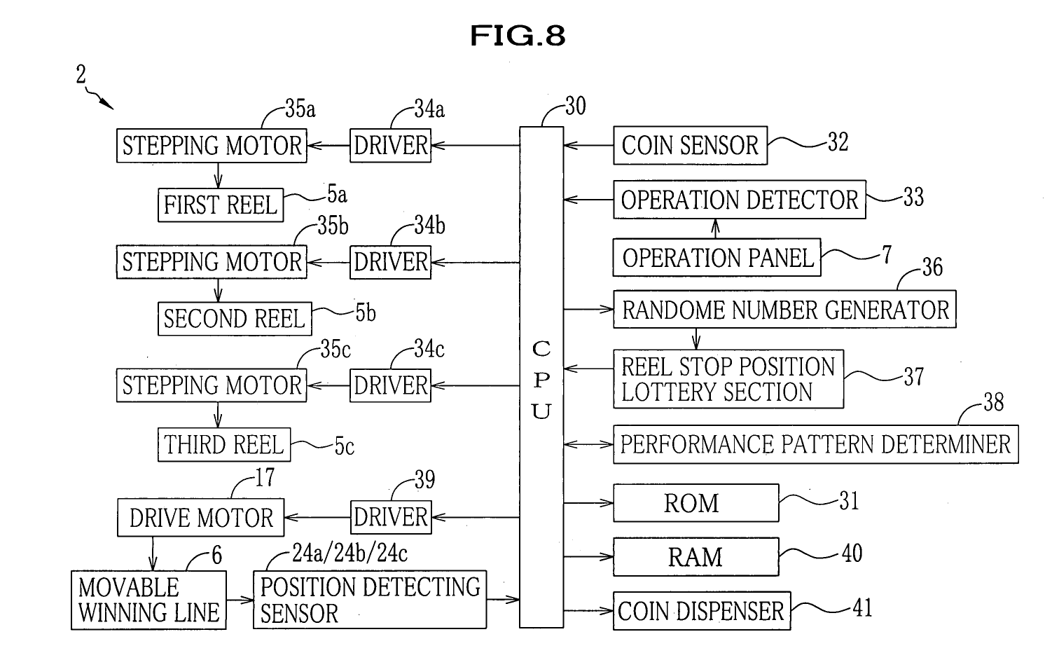

As shown in FIG. 3, an endless synchronous belt 14, which is formed annularly and has plural teeth therein, is trained between a driving pulley 15 and a driven pulley 16. The driving pulley 15 is attached to a rotation shaft of a drive motor 17 for rotating the synchronous belt 14. The drive motor 17 controlled by an after-mentioned CPU 30 (see FIG. 8) is attached to a first attachment fitting 18. Meanwhile, the driven pulley 16 is attached to a second attachment fitting 19.

A circular hole 20a in which the attachment bush 10 is fitted is formed in a stationary fitting 20 for attaching the movable winning line 6. The stationary fitting 20 is attached to the synchronous belt 14 so as to hold it between the stationary fitting 20 and an index member 21, and moved integrally with the rotating synchronous belt 14.

Each of photointerruptors (PI) 22a-22c having a pair of LED 25 and phototransistor 26 respectively disposed at predetermined intervals is attached to sensor substrates 23a-23c (See FIG. 4). A first position detecting sensor 24a is constituted of the PI 22a and the sensor substrate 23a; a second position detecting sensor 24b is constituted of the PI 22b and the sensor substrate 23b; and a third position detecting sensor 24c is constituted of the PI 22c and the sensor substrate 23c. The first, second and third position detecting sensors 24a-24c are disposed so as to pass the index member 21 through a gap between the LED 25 and the phototransistor 26 of each of the PI 22a-22c. Therefore, the first, second and third position detecting sensors 24a-24c can detect the position of the movable winning line 6 when the movable winning line 6 is moving with the index member 21 by driving the synchronous belt 14 to rotate.

The moving mechanism 13 is provided in the both sides of the reel unit 5. The first and second attachment fittings 18 and 19 and the sensor boards 23a-23c are firmly fixed to the attachment frame 3.

As shown in FIG. 4, a horizontal long hole 6b is formed in the attachment fitting 6a. One side of the attachment bush 10a is screwed by the screw 10b after inserting into the long hole 6b, so that the attachment bush 10a can be slid in a longitudinal direction (D1) of the long hole 6b. The other side of the attachment bush 10a is inserted into the slit 3b to fit in the circular hole 20a, and then screwed by a screw 10c to be fixed firmly to the stationary fitting 20, so that the attachment bush 10a can also be slid in the longitudinal direction (D2) of the slit 3b.

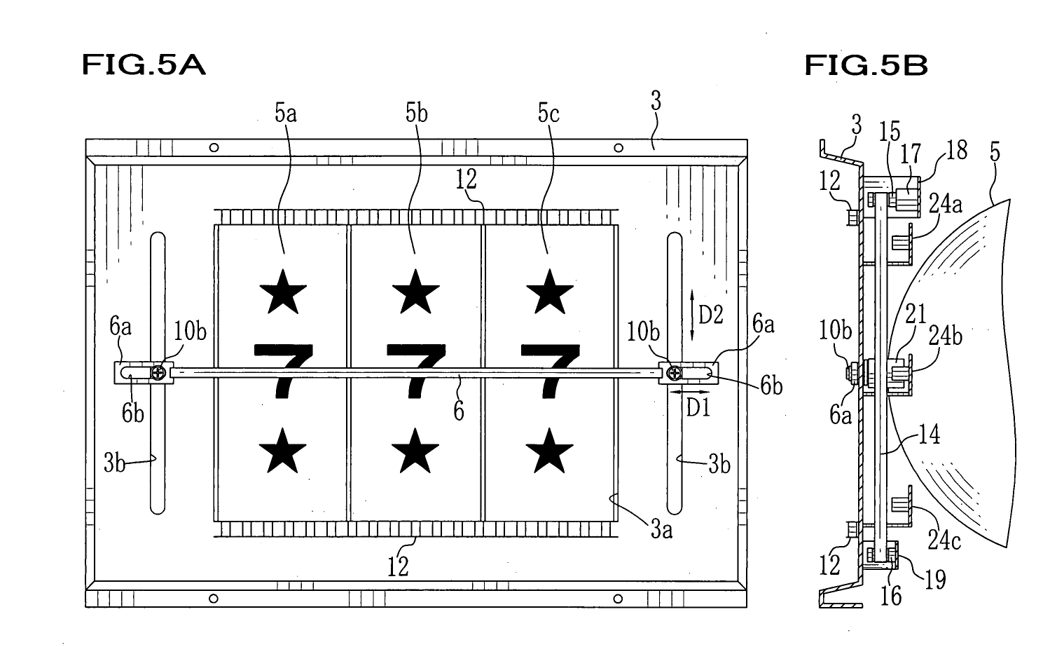

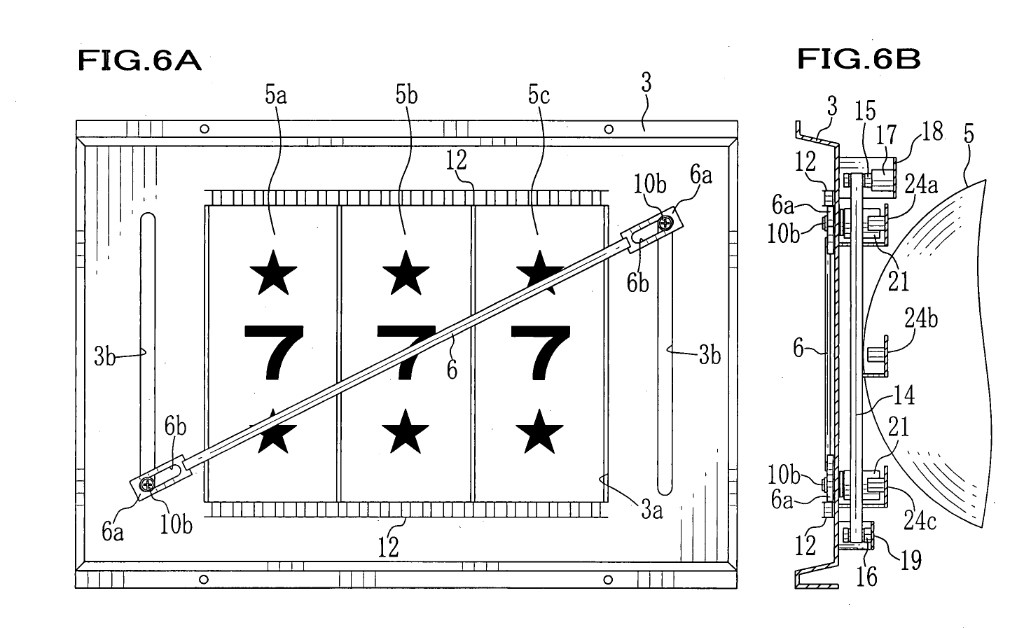

In FIG. 5, the opposite ends of the movable winning line 6 are positioned to be detected by the second position detecting sensor 24b. Accordingly, the movable winning line 6 keeps a horizontal state. In FIG. 6, one end of the movable winning line 6 is positioned to be detected by the first position detecting sensor 24a, but the other is positioned to be detected by the third position detecting sensor 24c. Therefore, the movable winning line 6 is tilted. Note that the display panel 4 is not shown in FIGS. 5 and 6.

The movable winning line 6 moved by the moving mechanism 13 can be moved up and down while keeping its horizontal state so as to show the winning symbol combination arranged linearly in the horizontal direction. In addition, the movable winning line 6 can also be tilted (see FIG. 6) so as to show the winning symbol combination arranged linearly in the oblique direction. The moving mechanism 13 can also move only one of the movable connectors 10 provided in the opposite ends of the movable winning line 6.

The movable winning line 6 can be tilted by sliding both the screw 10b and the attachment bush 10a engaging with the opposite ends of the movable winning line 6 in the longitudinal direction (D1) of the long hole 6b. Accordingly, the moving mechanism 13 can move the movable winning line 6 on a total of five virtual lines which consist of three horizontal lines and two diagonal lines respectively connecting the first, second and third position detecting sensors 24a-24c disposed in the both sides of the attachment frame 3.

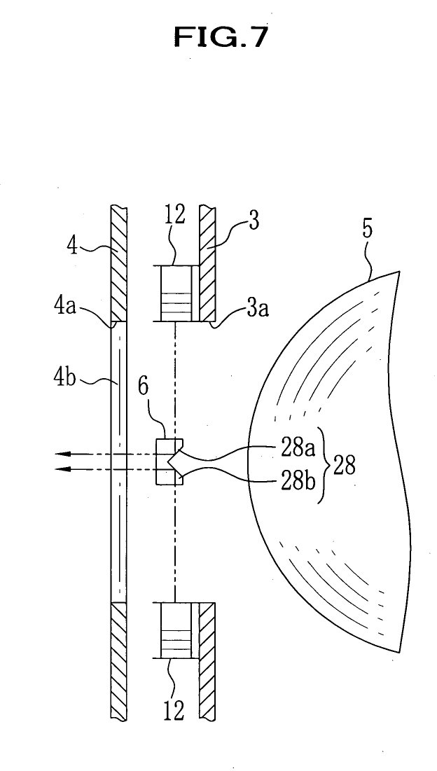

In FIG. 7, the movable winning line 6 is made of transparent resin material and so forth. A groove 28 is formed by cutting the back surface of the movable winning line 6 so as to form surfaces 28a and 28b. The light sources 12 are disposed on the upper and lower sides of the opening 3a. The light emitted from the LED of the light sources 12 enters the inside of the movable winning line 6 from the side thereof, and then the light is reflected by the surfaces 28a and 28b. Subsequently, the light passes through the transparent board 4b. Based on such constitution of the movable winning line 6, the player can visually confirm it certainly.

In FIG. 8, the slot machine 2 is operated when a CPU 30 reads a program for executing a game from a ROM 31. A coin sensor 32 provided behind the coin slot 8 inputs a coin-detecting signal in the CPU 30 every detecting of the insertion of proper coins.

When the bet button of the operation panel 7 is operated, an operation signal from an operation detector 33 is input in the CPU 30. A start signal is also input in the CPU 30 upon operating the start button of the operation panel 7. The CPU 30 activates drivers 34a-34c in response to the start signal. The drivers 34a-34c supply a driving pulse to stepping motors 35a-35c, which are respectively attached to the first, second and third reels 5a-5c, to rotate each reel.

A random number generator 36 generates random number value upon inputting the start signal in the CPU 30 and inputs the random number value in a reel stop position lottery section 37. The reel stop position lottery section 37 is provided with a reel stop position determining table for dividing all the generated random number value into groups, where the stop positions of the first, second and third reels 5a-5c are allocated.

When the reel stop position lottery section 37 is activated, the random number value is compared with an inner reel stop position determining table, so that each stop position of the rotating first, second and third reels 5a-5c is determined. Due to this, the kind and position of the symbols to be displayed in the display window 4a are determined. The signal that represents each stop position of the reels is input in the CPU 30, and then the CPU 30 controls the drivers 34a-34c in response to this signal, to stop the first, second and third reels 5a-5c at the respective determined stop positions after a predetermined period.

A performance pattern determiner 38 is operated to determine whether the movable winning line 6 is moved in response to the kind and the position of symbols to be displayed. If the movable winning line 6 is moved to another line, the line is determined randomly by the performance pattern determiner 38. There are two signals input in the CPU 30: one signal represents the performance pattern of the movable winning line 6 and the other represents the destination thereof determined by the performance pattern determiner 38.

When the movable winning line 6 is determined not to be moved, the win or the loss is determined whether the combination of three symbols along the line on which the movable winning line 6 exists at the start of game (e.g. a lateral center line shown in FIG. 5) corresponds to the predetermined winning symbol combinations (e.g. a “7 winning combination” including “7-7-7”).

Meanwhile, if the movable winning line 6 is determined to be moved, the CPU 30 controls a driver 39 in response to the signal representing the destination of the movable winning line 6, and then operates the drive motor 17 of the moving mechanism 13 disposed on the both sides of the reel unit 5, so that the movable winning line 6 starts to move toward the another line decided randomly (e.g. a tilted line shown in FIG. 6). At this time, the first, second and third position detecting sensors 24a-24c detect the positions of the ends of the movable winning line 6. Subsequently, when the detecting signal is input in the CPU 30, the CPU 30 controls the driver 39 in response to this detecting signal to stop the movable winning line 6 on the intended line. If the combination of three symbols on this line corresponds to the predetermined winning symbol combination, the win is decided. When the winning symbol combination is already completed on the line on which the movable winning line 6 is positioned at the start-of game, the CPU 30 cancels the movement of the movable winning line 6 and gives priority to this win. Namely, it is possible to prevent the winning completed before movement of the movable winning line 6 to be changed into the “loss” by moving the movable winning line 6.

The ROM 31 stores coin number data representing the number of prize coin determined based on the kind of the winning. If the win is decided, the CPU 30 stores the number of the prize coin in a RAM 40 by referring to the coin number data stored in the ROM 31. When the payout button of the operation panel 7 is operated, a coin dispenser 41 is driven to pay out coins corresponding to the number stored in the RAM 40 to the coin saucer 9. The RAM 40 has some areas for storing how many coins are betted or inserted, in addition to the number of prize coins. The RAM 40 is used as temporary storage memory for various data, which is generated through the process of the game.

Next, the game process in the slot machine 2 is explained. Some symbols, such as “7”, “star”, “BAR”, “2BAR”, “3BAR” and “WILD”, are printed on the outer surfaces of the first, second and third reels 5a-5c. The movable winning line 6 is positioned on a horizontal line (hereinafter referred to as a central horizontal line) crossing over the respective central parts of the reels at the start of game.

After inserting coins from the coin slot 8, the bet button of the operation panel 7 is operated to bet the coins (including the coins accumulated in the credit counter), and then the start button is depressed to rotate the reel unit 5. At the same time, the respective stop positions of the reels, whether the movable winning line 6 is moved or not, and the destination of the movable winning line 6 in the case of moving it are determined. After the predetermined period, the reel unit 5 stops rotating to display total of nine symbols of three symbols per reel through the display window 4a.

If the movable winning line 6 is not moved from the above-mentioned central horizontal line, the win or the loss is determined according to the combination of the three symbols arranged on the central horizontal line. If the symbol combination corresponds to the winning symbol combination, the prize coins are paid out. However, if it does not correspond, the game is over.

On the other hand, when the movable winning line 6 is moved from the central horizontal line, the winning is not completed on this line. After moving the movable winning line 6 to another line which is determined randomly, the win or the loss is determined based on the symbol combination along the movable winning line 6. If the symbol combination corresponds to the winning symbol combination, the prize coins are paid out; however, if it does not correspond, the game is over.

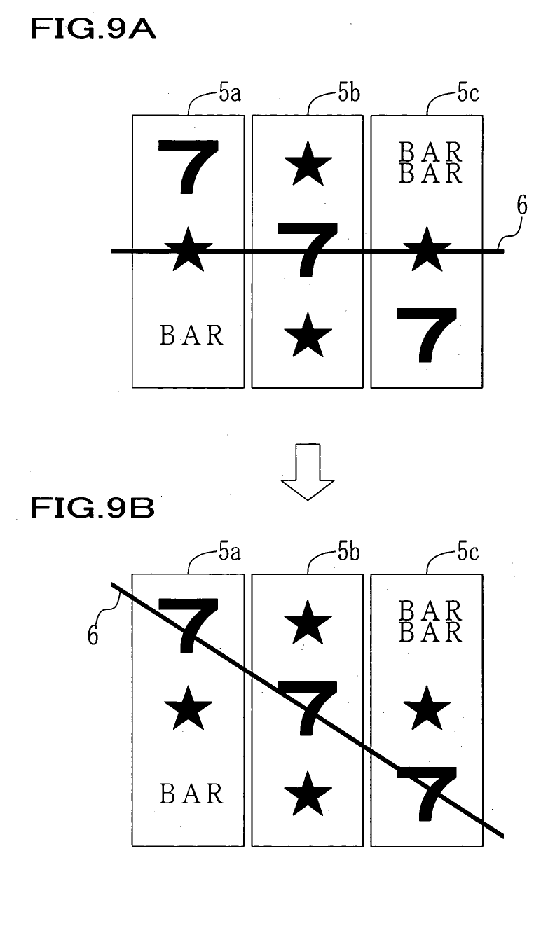

In FIG. 9A, since the symbol combination along the central horizontal line is “star-7-star”, the winning is not completed. In FIG. 9B, the symbols are arranged so as to form “7-7-7” by moving the movable winning line 6, so that the “7 winning combination” is completed. Accordingly, the “loss” can be changed into the “win” by moving the winning movable line 6.

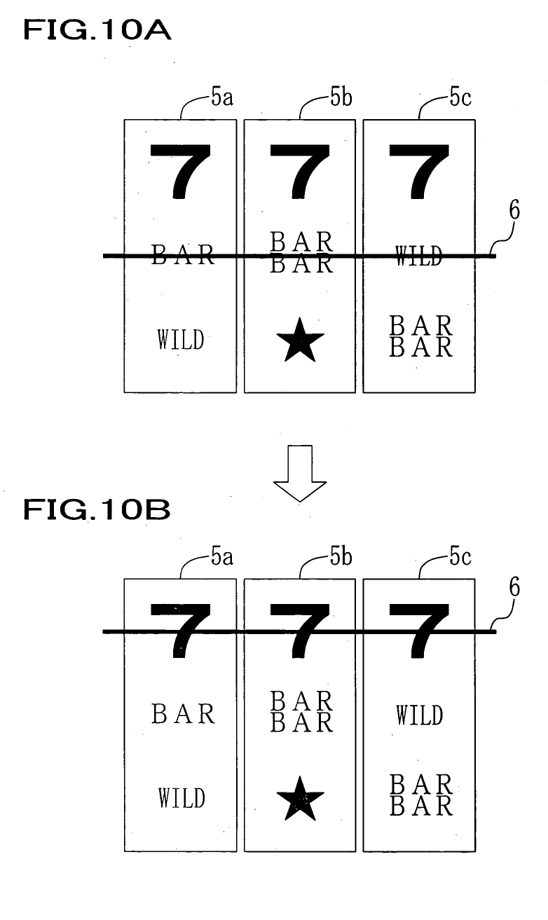

Even if the winning is already completed on the central horizontal line at the start of game, the movable winning line 6 may be moved without canceling when there is a winning symbol combination having a higher payout rate on another line. In FIG. 10A, the winning symbol combination “BAR-2BAR-WILD” as an “ANY BAR winning combination” is already completed on the central horizontal line at the start of game. In FIG. 10B, the higher winning symbol combination, the “7 winning combination” is completed by moving the movable winning line 6. Therefore, the winning symbol combination in starting the game can be changed into the higher winning symbol combination by moving the movable winning line 6.

In the display section of the above embodiment, although the symbols are displayed in motion by using the electronic rotation reels, the present invention is also applicable to a video-type reel displaying the symbols based on graphic data stored in the ROM so as to simulate the rotation of the reel.

Additionally, the bar-like member forming the movable winning line 6 of the present embodiment includes any linear members. Moreover, the winning line may be stretchy and elastic.

According to the above embodiment of the present invention, although single movable winning line 6 is used, a fixed winning line, which is printed on the transparent board 4b of the display panel 4, may be used with the movable winning line 6. In the case of the electronic game machine, the fixed winning line can be used with the movable winning line 6 even if there is the virtual winning line on the display screen of the display section.

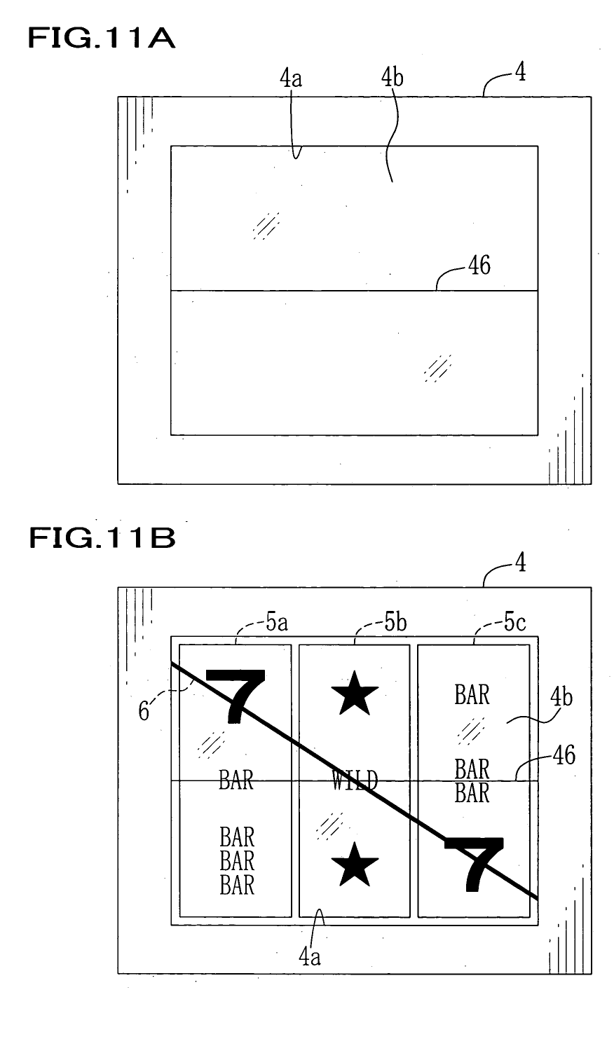

In FIG. 11A, a fixed winning line 46 is printed so as to cross over the central part of the transparent board 4b in a horizontal direction. In FIG. 11B, after the movable winning line 6 is moved, the winning symbol combination “BAR-WILD-2BAR” as the “ANY BAR winning combination” is completed along the fixed winning line 46, while the winning symbol combination “7-WILD-7” as the “7 winning combination” is completed along the movable winning line 6. Therefore, it is possible to increase the number of the winning lines. Note that the position and number of the fixed winning line 46 may be changed according to need, and, in addition, the fixed winning line 46 may be formed by use of light-emitting wire material instead of being printed on the transparent board 4b.

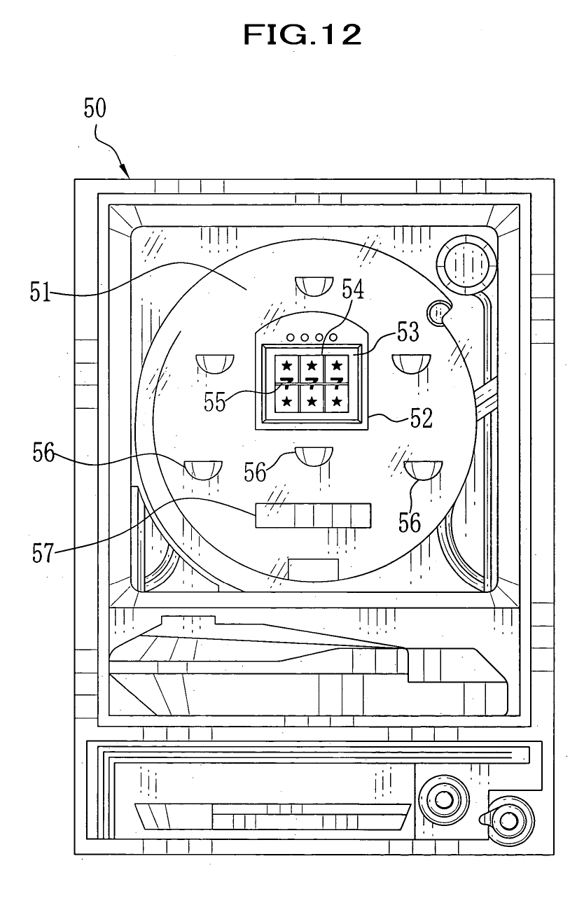

In the above embodiment, the slot machine is explained as an example of the game machine. The invention is not limited only to the slot machine, but is also applicable to other game machines, such as a pachinko machine. As shown in FIG. 12, in case of a pachinko machine 50, a reel unit 54 similar to the above embodiment, a movable winning line 55, a moving mechanism (not shown) and so forth are incorporated behind a display panel 53, which is attached to an attachment frame 52 formed approximately in a center of a front panel 51. When the game is performed by the pachinko machine 50, for example, if balls are dropped in specific prize openings 56 provided in the front panel 51, the reel unit 54 is rotated at a predetermined period. After the reel unit 54 has stopped rotating, the symbols are displayed as in the case of the above embodiment. At this time, the movable winning line 55 is moved in a similar manner to the above embodiment. If the symbol combination arranged along the movable winning line 55 corresponds to the winning symbol combination, a big hit state is generated. In the big hit state, attackers 57 open and close repeatedly for a predetermined period at a given number of times. It becomes possible to obtain a large number of prize balls when the balls are dropped in the attackers 57.

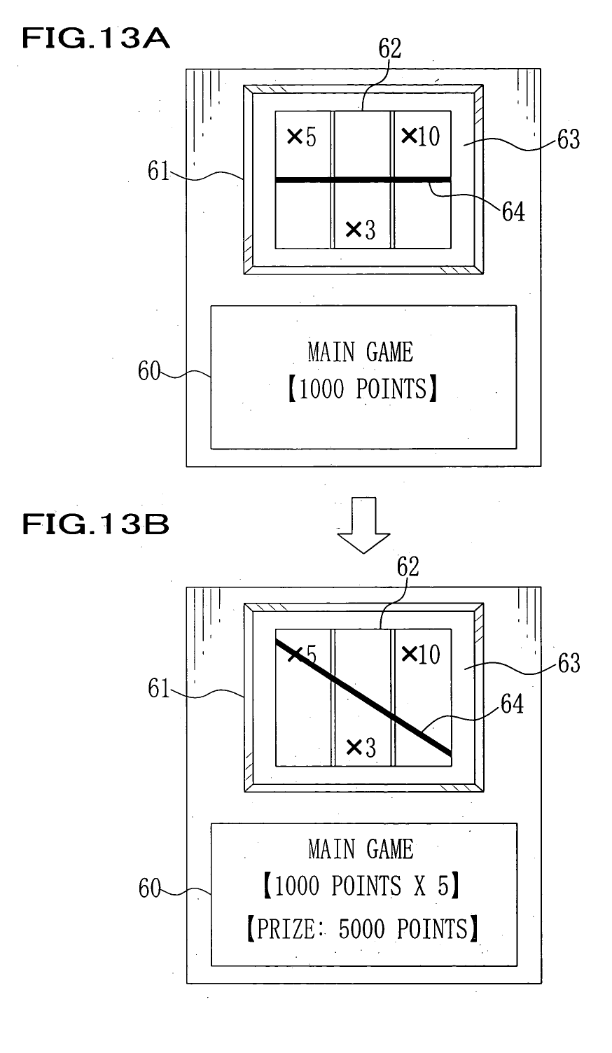

The display device having the above reel unit and movable winning line may be used for a sub game unit of the game machine. The sub game unit gives the chance to increase the points obtained in a main game unit, such that multiplies the prize based on the multiple number obtained in the sub game unit. For instance, as shown in FIG. 13A, when 1000 points are obtained in a main game unit 60, the multiple number, such as “×3”, “×5” and “×10”, printed on each reel of a reel unit 62 of a sub game unit 61 are displayed through a display panel 63 after the reel unit 62 stops rotating when a predetermined time has passed. In the same drawing, although any multiple number is not positioned on a movable winning line 64, the multiple number “×5” is generated by moving the movable winning line 64 to the position shown in FIG. 13B, so that 5000 points can be obtained. As the example of the main game unit 60, a video game may be used in addition to the slot machine. The content and kind of the game are not limited.

According to the above embodiments of the present invention, the winning line is changed dynamically by moving the movable winning line, so that it is possible to enhance the visual appeal to the player.

In the above embodiments, one movable winning line is provided in the game machine; however, the present invention is also applicable to provide plural movable winning lines by disposing the moving mechanisms so as to line up behind each other toward a depth direction of the game machine.

In the above embodiments, although the movable winning line is easily observed by irradiating the light emitted from the light source, the movable winning line may be a mere bar-like member, or an electro-luminescence (EL) tape, which emits light by applying a voltage, may be applied thereto.

In the above embodiments, the performance pattern determiner arbitrarily determines whether the movable winning line is moved or not. However, the movable winning line may be determined to be moved in response to the existence of the winning completed on the central horizontal line on which the movable winning line is positioned at the start of game. If the winning is completed on the central horizontal line, the movable winning line may not be moved, but if it is not completed thereon, the movable winning line may be moved to another line.

In the above embodiment, although the movable winning line is moved up and down by use of the endless synchronous belt of the moving mechanism, a stationary fitting, which is an attachment part to the movable winning line, may be attached to a spindle fixed to a shaft of a motor to move the movable winning line by the rotation of the motor. Additionally, the movable winning line may be moved on a rail, or a link mechanism may be used.

In the above embodiments, the moving mechanism is connected with the opposite ends of the movable winning line, and moves the opposite ends independently up and down directions. Additionally, the moving mechanism may be connected with one end of the movable winning line to move the one end up and down directions.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A game machine comprising:
a display section for displaying symbols in a stopped state after displaying plural kinds of said symbols in motion;
a movable winning line formed of a bar-like member and provided in said display section, a winning being completed when combination of said symbols displayed in the stopped state on said movable winning line corresponds to one of predetermined winning symbol combinations;
a moving mechanism for moving said movable winning line in said display section.

2. A game machine as claimed in claim 1, further comprising a connector for connecting at least one end of opposite ends of said movable winning line with said moving mechanism, said moving mechanism moving said at least one end of said movable winning line up and down directions through said connector.

3. A game machine as claimed in claim 2, wherein said moving mechanism is connected with said opposite ends of said movable winning line, said opposite ends of said movable winning line independently up and down directions through said connector.

4. A game machine as claimed in claim 1, wherein said moving mechanism moves said movable winning line after said symbols have been displayed in the stopped state by said display section.

5. A game machine as claimed in claim 2, wherein said moving mechanism further comprises:
a stationary fitting for attaching each of said opposite ends of said movable winning line through said connector;
a belt having an annular shape, said belt is trained between a driving pulley and a driven pulley, said stationary fitting is attached to said belt; and
a motor for driving said belt to rotate, said driving pulley is attached to a rotation shaft of said motor.

6. A game machine as claimed in claim 5, wherein said connector comprises:
an attachment bush having a first end and a second end, said first end fits into a circular hole provided in said stationary fitting by being inserted in a slit, said second end is inserted into a long hole, said slit is formed in an attachment frame provided in said display section and extends in up and down directions, said long hole is formed in an attachment fitting attached to said opposite ends of said movable winning line and extends in a parallel direction to said movable winning line;
a first screw for fitting said attachment bush to said stationary fitting; and
a second screw for fitting said attachment bush to said attachment fitting.

7. A game machine as claimed in claim 5, wherein said moving mechanism further comprises an index attached to said belt and a position detecting sensor for detecting a position of said index.

8. A game machine as claimed in claim 5, wherein said motor is attached to a first attachment fitting, said driven pulley is attached to a second attachment fitting, said first and second attachment fittings are fixed to said attachment frame provided in said display section.

9. A game machine as claimed in claim 7, wherein said position detecting sensor is constituted of a photointerruptor and a sensor board to which said photointerruptor is attached, said sensor board is fixed to said attachment frame provided in said display section.

10. A game machine as claimed in claim 1, further comprising a light source for illuminating said movable winning line.

11. A game machine as claimed in claim 10, wherein said light source is an LED attached to upper and lower sides of a rectangular opening formed in said attachment frame provided in said display section.

12. A game machine as claimed in claim 10, wherein said movable winning line is made of transparent material and provided with a groove having cutting surfaces, light emitted from said light source is entered in said movable winning line and reflected on said cutting surfaces to be emitted out of said display section.

13. A game machine as claimed in claim 1, wherein an EL tape is applied to said movable winning line.

14. A game machine as claimed in claim 1, further comprising a fixed winning line provided in said display section, a winning being completed when said symbol combination displayed in the stopped state on said fixed winning line corresponds to one of the predetermined winning symbol combinations.

15. A game machine as claimed in claim 1, wherein said display section has an electronic display on which said symbols and a virtual winning line are displayed, the winning is completed when said symbol combination displayed in the stopped state on said virtual winning line corresponds to one of said winning symbol combinations.
